(19) United States
(12) Patent Application Publication
(10) Pub. No.: US 2012/0018410 A1
(43) Pub. Date: Jan. 26, 2012

(54) Microwave Plasma Generating Plasma and Plasma Torches

(75) Inventors: Zenon Zakrzewski, Gdansk (PL); Michel Moisan, Outremont (CA); Daniel Guerin, Chelles (FR); Jean-Christophe Rostaing, Versailles (FR)

(73) Assignee: L'Air Liquide Societe Anonyme Pour L'Etude Et L "Exploitation Des Procedes Georges Claude, Paris (FR)

(21) Appl. No.: 12/679,231

(22) PCT Filed: Sep. 16, 2008
(86) PCT No.: PCT/FR08/51659

§ 371 Date: Oct. 3, 2011

(30) Foreign Application Priority Data
Sep. 20, 2007 (FR) 0757719

(51) Int. Cl. B23K 9/00; H05H 1/46

(52) U.S. Cl. 219/121.48; 315/111.21

(57) ABSTRACT

The invention relates to a plasma generating device that comprises at least one very high frequency source (>100 MHz) connected via an impedance adaptation device to an elongated conductor attached on a dielectric substrate, at least one means for cooling said conductor, and at least one gas supply in the vicinity of the dielectric substrate on a side opposite to that bearing the conductor. The invention also relates to plasma torches using said device.

The invention relates to devices for generating plasmas by coupling electromagnetic power into a gas. Such devices are also called “plasma sources”. The terms “plasma generating device” and “plasma source” will be used interchangeably in the present description.

In order for cold-plasma surface treatment technology to become commonplace, there is a need to improve the devices used for generating these plasmas by coupling electromagnetic power into a gas. These devices or “plasma sources” must be:
simple and inexpensive;
suitable for linear geometries and possibly for nonplanar geometries; and
capable of operating in a wide range of pressure levels between a substantial vacuum, of the order of 10⁻² mbar, and atmospheric pressure or even above atmospheric pressure.

Furthermore, the efficiency in transmitting the electromagnetic power coming from the generator into the plasma must be as high as possible, i.e.:
the operation must generate only minimal loss by heating of the structure of the device for coupling the electromagnetic power into the plasma;
the residual radiation to the outside must be negligible (for security and for the impossibility of interference with devices operating in the vicinity at the same prescribed industrial frequencies); and
only a small fraction of the incident power must be reflected back to the generator, i.e. there must be good impedance matching between the power supply line and the plasma source using this same power.

The latter condition must remain true as long as possible for a wide range of operating regimes, without it being necessary to make readjustments in real time.

Plasmas excited by very high frequencies (especially greater than around one hundred megahertz, including microwave frequencies), for example 434 MHz, 915 MHz, 2450 MHz and 5850 MHz (frequencies prescribed by the international regulations for the IMS (industrial, scientific and medical) band, are of particular interest because of their high electron density. This means a more intense activation of the physico-chemical processes in the discharge, especially a high rate of formation of the active species involved in a surface treatment process. This treatment is therefore more comprehensive and/or more rapid: for example, the rate at which materials can be deposited in the form of thin films is higher and the production yield is more favorable.

Above a limit of a few tens of MHz, electromagnetic waves, because of their propagation properties, cannot be applied to a gas in order to create a plasma by means of electrodes connected to a power supply circuit, as in the DC or radiofrequency case. The microwaves are conveyed from the generator via a hollow rectangular waveguide or a coaxial cable, before being guided by a conducting structure of a specific architecture internal or contiguous with the treatment chamber. This chamber must allow distribution and distributed absorption of the microwaves in order to create a sufficiently uniform plasma with the required characteristics.

Microwave plasma generator devices have been developed among which the following may be mentioned in particular: the “duo plasmaline” system (E. Rauschle et al. J. de Physique IV (8), PR7, 99 (1998)); two-dimensional slotted-antenna applicators (H. Sugai, Plasma Fusion Research 72, 621 (1996) and H. Sugai et al., Plasma Sources Science and Technology 7, 192 (1998)); microstrip field applicator sources for analytical applications (A. M. Bilgic et al., Plasma Sources Science and Technology 9, 1-4 (2000)); electron cyclotron resonance systems; and multi-dipole magnetron systems.

However, all these devices have a complex architecture and are expensive to produce. Moreover, they are too dependent on a given configuration and size for the plasma treatment reactor.

Staying in particular with the studies by the Bilgic et al. team, one of whose publications was mentioned above, (the reader may also refer to the documents DE-198 51 628 and US 2003/008068), these relate to the use of microstrip systems. However, it should be clearly noted as regards these studies that the source in question is of very small size and is intended to sustain plasmas with a low power (about 10 W) at atmospheric pressure in argon in a capillary channel (with a cross section of about 1 mm²) bored axially in a silica rod of rectangular cross section. The plasma channel of very small cross section is entirely within a microstrip transmission line. There is no mention in this work of the possibility of extending the system to two or three dimensions, and it is difficult therefore to imagine the possibility of using such a structure for the continuous treatment of large areas.

As will be described in greater detail in what follows, with the aid of comparative figures, the systems described by Bilgic et al. employ a continuous conducting plane, kept grounded, on the opposite face of the dielectric, which solution has drawbacks, among which are:
the coupling into the plasma is rather of the resonant type, which it is better to avoid since the impedance matching is then tricky to achieve and is often an unsupportable constraint in the case of actual practical applications; and
in such a configuration, there are not too many ways of positioning the plasma: a channel may be cut out in the dielectric, or else the ground plane may be placed at some distance from the lower face of the dielectric, but in all cases this distance is limited to a few mm (since the stripline and the ground plane must “see each other” electrically), which will in practice considerably limit the applications of such a configuration.

It will now be explained how we produce, according to the invention, traveling wave propagation and not resonant coupling, and how, when this is necessary, we eliminate the depth constraint. In particular, we will see that the present invention can be credited with the idea of considering the plasma as a conductor with an intrinsic potential and therefore said conductor can pretty well serve as a ground reference, supporting, by itself, the propagation of the traveling wave that creates it.

The inventors have found, surprisingly and unexpectedly, that plane sources based on microstrip field applicators, and more generally those using an elongate conductor of small cross section compared with its length (whether of the microstrip type or of the hollow, for example, cylindrical, line type), constitute very simple plasma sources that are easy to employ and have all of the required qualities.

Thus, the plasma generator device according to the invention comprises at least one very high-frequency source connected to an elongate conductor of small cross section compared with its length (for example of the microstrip type or hollow line type) which is fixed to a dielectric support, at least one impedance matching means between the very high-frequency source and the connection to the conductor, at least one means for cooling said conductor, and at least one gas feed close to the dielectric support on the opposite side from the side supporting the conductor.

As will have been understood in reading the foregoing, the expression “very high-frequencies” means according to the invention frequencies above 100 MHz, and especially the “discrete” frequencies of 434 MHz, 915 MHz, 2450 MHz and 5850 MHz which are prescribed by the international regulations for the ISM (industrial, scientific and medical) band.

Likewise, the gas feed being termed “close to” or “in the vicinity of” the dielectric support is understood to mean an inlet typically opening at most 15 mm from the support and preferably at most 10 mm from the support.

The plasma is generated below that surface of the dielectric which is opposite the surface supporting the conductor, and facing the latter. Thus, the device according to the invention may be moved with respect to the surface to be treated in such a way that the plasma is in contact with this surface to be treated, or else the surface to be treated may be run beneath the plasma-generating zone, the device according to the invention then remaining stationary. Depending on the orientation of the conductor relative to the surface to be treated and depending on the distance separating the dielectric from the surface to be treated, the treatment will take place directly by the plasma or by the post-discharge plasma. The term “post-discharge plasma” is understood by those skilled in the art to mean the region immediately contiguous with the actual plasma zone, characterized by its intense luminescence.

In the post-discharge plasma, the charged species have practically disappeared, but neutral excited and/or active species still remain. Thus, when the conductor is perpendicular to the surface to be treated, said surface does not encounter the plasma zone and the treatment will take place by post-discharge plasma, whereas when the conductor is parallel to the surface to be treated (the most common case), the treatment will take place by direct contact with the plasma.

In the present invention, the term “microstrip” is understood to mean an electrical conductor element of elongate shape and small thickness, typically of the order of one millimeter or less than one millimeter. The microstrip can have any length and any width, these dimensions being such as to optimize the power propagation properties along the transmission line formed by the microstrip. As a variant, and as already mentioned above, the microstrip may be replaced with a hollow elongate element, especially one of round, rectangular or square cross section, the wall thickness of the hollow tube being sufficient for good mechanical strength and having no effect on the electrical behavior. The microstrip/conductor is not constrained to a plane, rectilinear geometry, but may also adopt a curved shape in the plane or a warped shape in its length direction with concave or convex curvatures.

As will have been understood, terms “conductor” and “microstrip” are used interchangeably in what follows, without at any moment the present invention being restricted to just one of these types of line.

Because the high-frequency currents flow by obeying the skin effect and because this depends on the frequency and the conductivity of the material constituting the conductor, the practical thickness in which the current flows will be very much less than 0.1 mm. However, because the transported power levels are high, of the order of a few hundred watts, and because the conductivity of the metal decreases with increasing temperature, the thickness of the microstrip will be very much greater than the theoretical thickness defined by the skin effect and it will be necessary to cool the microstrip so that its physical integrity is preserved. Thus, the microstrip will have a thickness of the order of one millimeter and be made of a material which is a good electrical and thermal conductor, both these factors being chosen so as to have good mechanical strength, which may be copper alloys such as, for example, brass or preferably beryllium copper. To maintain the good conductivity of the microstrip, it may be advantageous to coat the surface of said microstrip with a coating of a metal which is at least as good an electrical conductor and insensitive to oxidation (for example gold). This guarantees that the good electrical characteristics are maintained over time in a normal operating environment in which copper alloys have a tendency to oxidize slightly or to be surface-contaminated.

Advantageously, the microstrip conductor is mechanically pressed against the dielectric. It may also be screen-printed on the dielectric if the power levels involved are low enough.

The dielectric used must have not only good electrical properties, i.e. a low ratio of the imaginary part of its dielectric function to the real part thereof (i.e. tanδ), typically between 10⁻⁴ and 10⁻², resulting in low dielectric loss at the operating frequency in question, but also excellent heat shock capability (the thermal gradient due to the plasma in contact with the wall opposite the microstrip may be very high).

Thus, it is possible to choose, as dielectric, either silica, for its excellent heat shock resistance, or preferably a ceramic, especially boron nitride or aluminum nitride.

Various means for cooling the microstrip may be used. According to a first embodiment, coolant is made to circulate in an insulating housing placed on the dielectric and above the microstrip, which coolant is electrically insulating and has a dielectric constant ε lower than that of the solid dielectric of the substrate. The coolant must have good heat-transfer capability. It must also be a good dielectric so as neither to disturb the propagation of the electromagnetic waves along the line nor dissipate a substantial fraction of the power by absorption. The dielectric heat-transfer fluid may for example be advantageously an α-olefin such as tetradecene (C14). Thus, the device according to the invention includes a housing placed on the dielectric and on top of the microstrip, confining the circulation of the coolant.

According to a second embodiment, the cooling is carried out indirectly by placing, over the entire free face of the microstrip, a heat sink made of a dielectric, which may be a ceramic, and preferably having good thermal conductivity (e.g. alumina, or aluminum nitride), in which a coolant circulates. In this case, since the coolant does not circulate in direct contact with the microstrip but at a certain distance therefrom, it does not circulate in a region of high electromagnetic power density and is not restricted to low absorption of the waves, which fluid may consequently be water.

According to a third embodiment, in the case in which the microstrip is replaced with a hollow elongate conductor element, a coolant circulates in the hollow part of said element. The coolant may be water since the electromagnetic field is zero on the inner wall of the hollow element. This is because the wall thickness of said element is very much greater than the skin depth. This solution provides better cooling than the cooling systems described above and enables larger very high-frequency currents to flow, and therefore results in higher transmitted power without increasing the electrical losses. The line thus formed with a hollow conductor of rectangular, square or circular cross section can be likened to a hybrid structure from the electrical standpoint in comparison with a plane microstrip line. Experimentally, it has been confirmed that this type of line has a characteristic impedance relatively close to that of a microstrip structure. The fact of no longer having an intermediate heat sink considerably simplifies the arrangement, and contact between the electrode and the dielectric is provided by a clamping device identical to the arrangement of a plane microstrip structure.

According to another embodiment, the device according to the invention may also be provided with at least one means for cooling the dielectric. A cooling means may consist of channels provided in the dielectric, through which a coolant circulates. Another means may consist in placing the dielectric on a support having channels through which a coolant circulates.

So as not to emit microwaves into the external environment, something which would be a waste of the power and would create operator safety or electromagnetic compatibility problems, it is advantageous for the microwave power coupling device formed by the microstrip line to be enclosed in a conducting housing acting as a Faraday cage.

Depending on the frequency used, the power supply for the devices according to the invention may be transposed directly from the power semiconductor industry applied to telecommunications. Power generators based on this “solid state” technology are more compact and more reliable than generators based on vacuum tubes, such as magnetrons supplied by a switch mode power supply. Unlike magnetrons, solid-state power generators require no maintenance, in particular periodic replacement of a magnetron is eliminated. Furthermore, the cost of these generators drops rapidly with medium-volume and high-volume production.

The microstrip lines may be supplied in various ways:
in traveling wave mode, by connecting the very high-frequency wave generator to just one end of the microstrip and connecting an impedance-matched load to the other end of the microstrip;
in traveling wave mode, by connecting a very high-frequency wave generator to each of the ends of the microstrip in order, on the one hand, to increase the total power and, on the other hand, to compensate for the attenuation of the wave by absorption during its propagation, so as to sustain the plasma. In this case, it is necessary to use a different generator at each end so that there is no phase correlation between the two signals, otherwise a standing wave mode would be established;
in standing wave mode, by connecting a very high-frequency wave generator to only one end of the microstrip and by providing an adjustable short circuit at the opposite end, in order to provide impedance matching; and
in standing wave mode, by connecting a very high-frequency wave generator to a divider device, each of the branches of which is connected to one of the ends of the microstrip.

The lines and connectors are provided by standard commercial components (for example by a coaxial cable having a 50-ohm characteristic impedance).

The device according to the invention has the additional advantage over waveguide systems that the impedance matching is also easier to achieve. For example, the conversion and impedance-matching components may be produced in the form of conventional matching circuits (circuits consisting of inductors and capacitors), but also directly in the actual structure of the microstrip lines by producing therein a quarter-wave impedance transformer (the principle of which is known to those skilled in the art), or by adding suitable lengths of microstrip (these being called “stubs” in this industry), as propagation line excrescences with, as corollary, integration simplicity, impossibility of detuning (values being fixed by the geometry and the nature of the dielectric employed) and optimization of the very high-frequency power transfer (lower loss in the connectors and links).

Thus, the impedance matching between the very high-frequency generator and the microstrip applicator may be achieved by a T or π or L circuit, or by using a stub perpendicular to the microstrip. The impedance matching and therefore the dimensions of the stub and the microstrip are within the competence of a person skilled in the art and may be determined using a quasistatic analysis in which the starting point is the assumption that the propagation mode is exclusively TEM (see the publications by Gupta et al., “Microstrip lines and slot lines” and K. C. Gupta, R. Garg and I. J. Bahl (Hartech House, Norwood, Mass., 1979). In particular, a person skilled in the art would know how to adapt the impedance of the devices in which the microstrip is immersed in a coolant with a dielectric constant greater than 1, or in which a dielectric heat sink of dielectric constant greater than 1 is pressed against the microstrip.

In order for a larger area to be treated simultaneously and uniformly, it is advantageous to combine several devices according to the invention. By juxtaposing a plurality of plasma generator devices is possible in fact to generate a plasma sheet over large areas, which in all events applies to continuous treatment on the run.

It is possible to combine as many elements as are needed to carry out a continuous surface treatment with the desired production yield. Each of the plasma generator devices thus combined includes at least one very high-frequency source connected via an impedance matching system through a microstrip conductor fixed to a dielectric support, at least one means for cooling said microstrip and at least one gas feed close to the dielectric support on the opposite side from the side supporting the microstrip.

For surface treatment applications operating at atmospheric pressure with the need to run the substrate beneath the active zone, it is possible to conceive of various arrangements of plasma modules that can be easily integrated, while still benefitting from the inherent simplicity of this type of source.

The plasma generator devices may be placed end to end so as to cover the width of the substrate or may be offset in the run direction so as to overlap the area to be treated. It is also possible to add the plasma generator devices in the run direction so as, if necessary, to increase the time in contact with the active zone, depending on the run speed, in particular so as to increase the productivity.

The assembly consisting of the various devices may be joined together by means of a common base or mechanical structure which fulfils the gas delivery and cooling functions and the electromagnetic power connections.

Advantageously, the connections may be very limited, by connecting the amplifier module of the very high-frequency power generator, together with its integrated impedance matching device, directly to the microstrip.

The assembly consisting of various plasma generator devices joined together by means of a base or mechanical structure, which fulfils the gas delivery and cooling functions and the electromagnetic connections, has in particular the following advantages:
it is simple to produce and to integrate, thereby making mass production possible and limiting the manufacturing costs, and making maintenance easy;
by reducing the electrical connection to a single connector (not a coaxial cable), the losses in transporting the power to the plasma module are reduced, this having an important impact on the design and therefore the cost of the very high-frequency part.

Furthermore, with the devices according to the invention, it is possible to use plasma module excitation frequencies a little lower than those in the microwave range, such as for example 434 MHz (ISM band), making it possible to benefit from the all-semiconductor technology with a good yield.

Another subject of the invention relates to modular small-sized moderate-power plasma torches that also benefit from the same advantages as those described above. These plasma torches have the same arrangements and forms (microstrip/flat or hollow conductor) as the above applicators. More particularly, a longitudinal channel passes right through the dielectric on which the conductor is placed. Gas is injected via one of the ends, and the plasma forms in the channel, extending over the entire length thereof. By varying the gas flow rate and the very high-frequency power, it is possible either to extract the plasma at the end of the torch or to use the post-discharge plasma thereby moving the substrate to be treated further way. The cross section of the channel may of course be optimized so as to confine the plasma.

Thus, a plasma torch according to the invention comprises at least one very high-frequency source with its integrated impedance matching device connected to a conductor (for example of the microstrip type or hollow conductor type) fixed to a dielectric support and at least one means for cooling said conductor, said dielectric support being longitudinally penetrated by a channel via one end of which the gas is injected and in which the plasma forms.

Because of its simple design, it is possible to use this type of plasma torch on a robot arm so as to apply the plasma treatment by scanning a surface to be treated.

According to one of the aspects of the invention, the device according to the invention, and contrary to what the prior art recommends (i.e. the presence of a ground plane extending at least facing the entire surface of the conducting transmission line, on the opposite surface of the dielectric) the device according to the invention therefore includes a ground plane, but this is in no case continuous, only a minor area of the transmission line (microstrip or conductor) facing a ground plane.

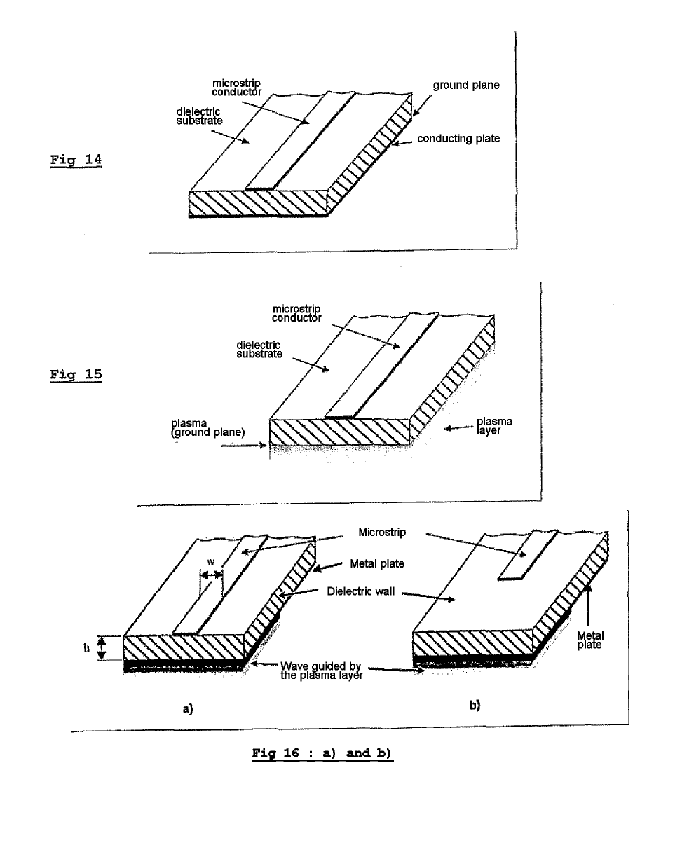

This aspect of the invention will be described in conjunction with the appended FIGS. 14, 15 and 16 which illustrate the case in which an elongate conductor of the microstrip type is used.

FIG. 14 illustrates the case of the prior art involving in particular the work by the Bilgic et al. team. The structure is made up of a microstrip and a complete continuous ground plane, these being separated by the dielectric substrate. In this case, as already mentioned, it is implicitly impossible to sustain the plasma beyond the geometrical boundary formed by this complete continuous ground plane, for example to treat a substrate placed in an extended chamber located thereunder. In fact, another useful configuration could be used, noting that a microwave edge field extends into the space from the lateral slots defined between the edges of the microstrip and the ground plane. Of course if there is no field confinement in the nearby zone lying above the microstrip conductor and the dielectric, then it is possible, as an alternative, to create an extended plasma in this zone (by optionally providing a dielectric superstrate between which and the substrate the microstrip conductor line is sandwiched, said substrate then being able to constitute the window of a treatment chamber. However, this arrangement would hardly be advantageous since, on the one hand, it is more complex and, on the other hand, the plasma can be sustained only by the edge fields leaking through the slots defined between microstrip conductor(s) and ground plane, and therefore in a spatially discontinuous manner. In particular at atmospheric pressure, this is a very serious drawback since, owing to the short mean free path, it will be very difficult to make the plasma homogeneous so as to be useful in practice. The width of the microstrip conductor and the thickness of the substrate are small compared with the wavelength in free space. The mode of propagation along such a line is to a first approximation the TEM mode. However, embodiments would also be conceivable in which the active conducting parts are instead in the form of rectangles. However, this arrangement is not a priori more advantageous than the previous one.

At the end of the day, a configuration (of the Bilgic et al. or other type) in which a complete continuous ground plane exists appears to be fraught with particularly unacceptable drawbacks.

As also mentioned earlier, the present invention can be credited with having thought of considering the plasma sheet as a conductor with an intrinsic potential, which therefore can serve perfectly as a ground reference. The arrangement shown in FIG. 15 is then obtained. In this case, the field wave also extends into the plasma. To “launch” such a wave, a suitable distribution of the field in the straight section of the propagation line must be imposed at the start of the line.

The present invention thus provides a partial metal ground plane at the start of the line (at the point where the microwaves enter), which will suffice for launching and sustaining the propagation of the traveling wave and for sustaining a continuous plasma over the entire length of the line, facing the latter and beneath the dielectric.

More generally, according to one of the embodiments of the invention, a ground plane fraction is used, but its projection normal to the propagation line intercepts a minor area of the section of the line.

The appended FIGS. 16-a) and 16-b) therefore illustrate two embodiments of the invention.

The wave launch zone, at the inlet of the transmission line, has a conventional structure, with the microstrip, a metal ground plane and the dielectric wall of the treatment chamber serving as substrate. The metal ground plane is interrupted a short distance from the entry and is replaced with the plasma extending with the microstrip over the entire remainder of the length of the conductor line (FIG. 16-a)).

But it is also possible, because the interface between a dielectric wall and a plasma sheet can form a guiding structure for an electromagnetic wave, as an alternative, to dispense with extending the microstrip substantially beyond the boundary of the metal ground plane (FIG. 16-b)). In this case, the analog of a device and of a surface wave plasma mode, but in a plane geometry, is then obtained.

The partial surface of the microstrip facing which is a ground plane fraction may not be solely at the start of the line (end edge) but may also take the form of an overlap of the lateral edges of the microstrip with a ground plane boundary line. For example, a window substantially matching the shape of the microstrip, but slightly smaller, may be open in the ground plane surface.

Other features and advantages of the invention will now be explained in detail with the aid of the appended drawings in which:

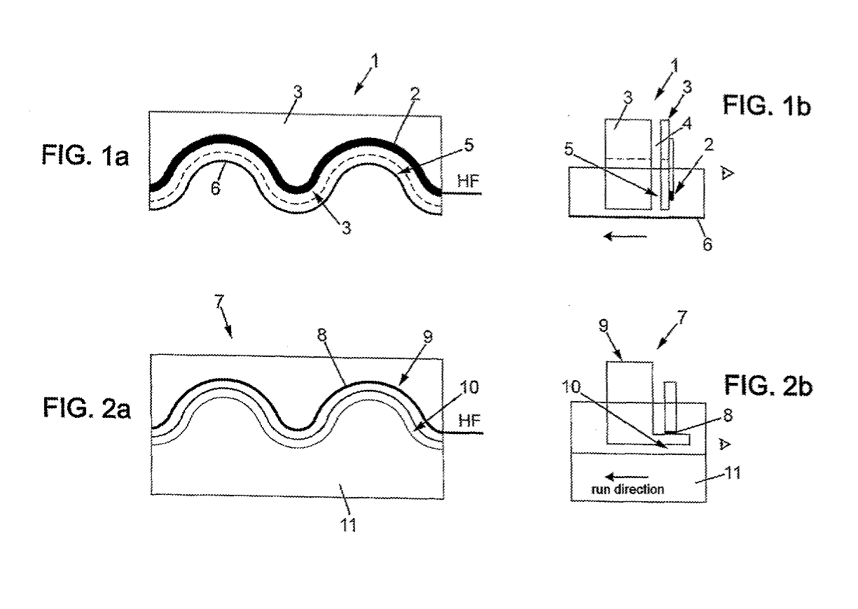

FIGS. 1a-1b show front and sectional views of an embodiment of the device according to the invention, in which the microstrip is plane but of curved shape, enabling a nonplanar surface to be treated by post-discharge plasma;

FIGS. 2a-2b show front and sectional views of an embodiment of the device according to the invention in which the microstrip is of warped shape, enabling a nonplanar surface of a substrate to be directly treated in the plasma;

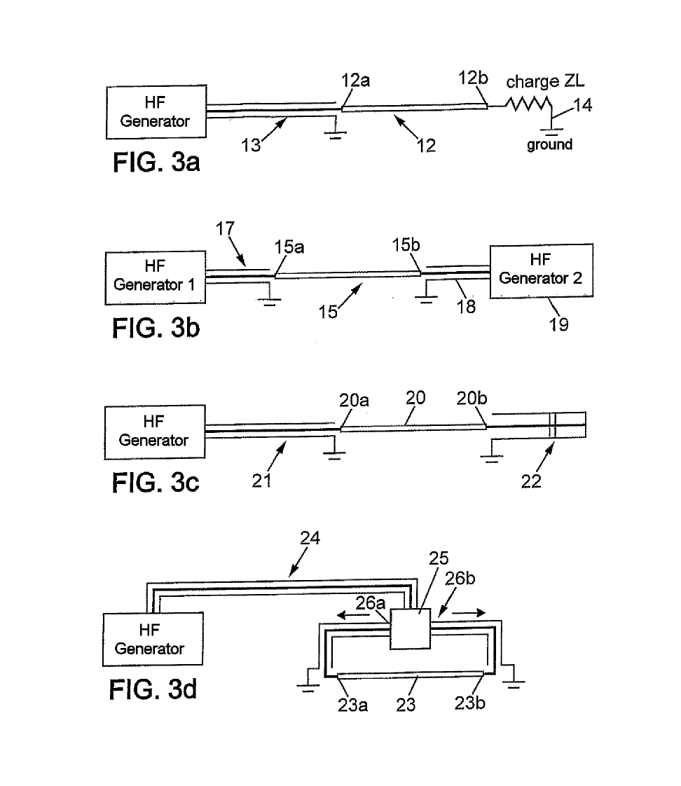

FIGS. 3a-3d show schematically various connections of the microstrip conductor to the very high-frequency generator;

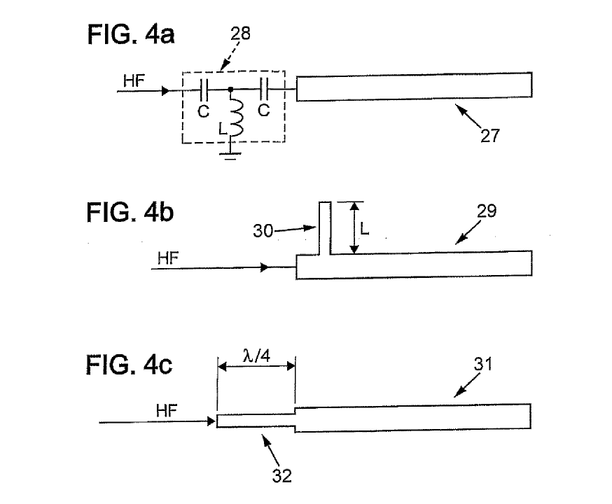

FIGS. 4a-4c show schematically possible ways of matching the impedance of the device;

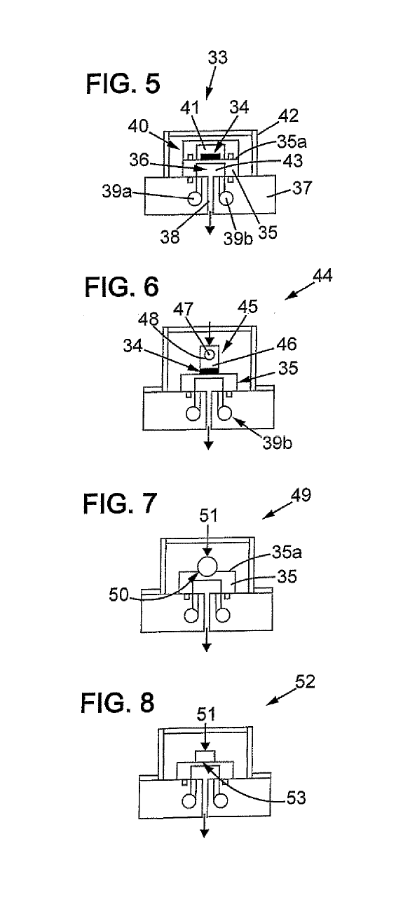

FIG. 5 shows, in cross section, a device according to the invention with a plane microstrip provided with a first embodiment of the cooling means;

FIG. 6 shows, in cross section, a device according to the invention with a plane microstrip provided with a second embodiment of the cooling means;

FIGS. 7 and 8 show, in cross section, a device according to a second embodiment of the invention with a propagation line element of hollow cross section, this being an alternative to the microstrip;

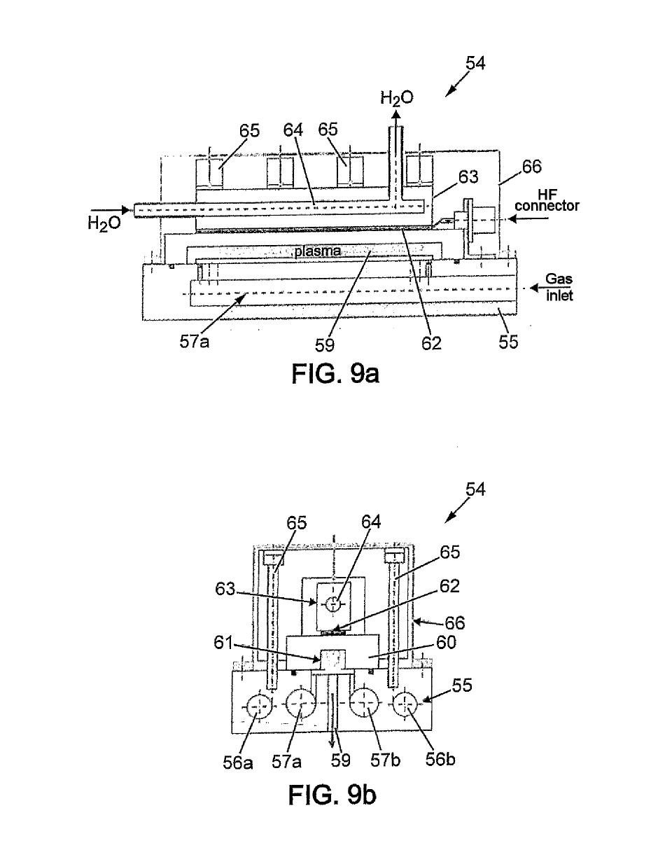

FIGS. 9a and 9b are representations, in longitudinal section and cross section, of a device according to the invention, provided with a plane microstrip;

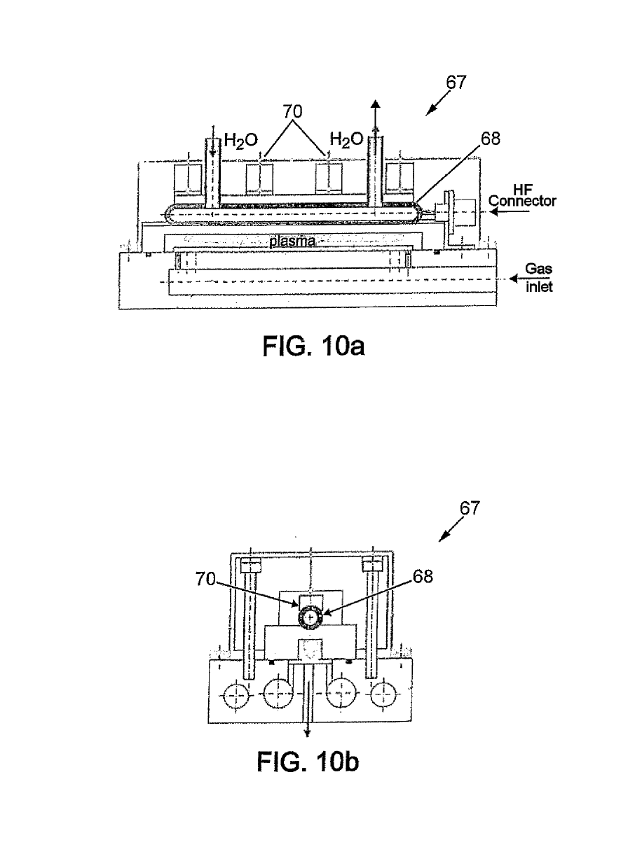

FIGS. 10a and 10b are representations, in longitudinal section and cross section, of a device according to the invention provided with a propagation line element of hollow cross section, this being an alternative to the microstrip;

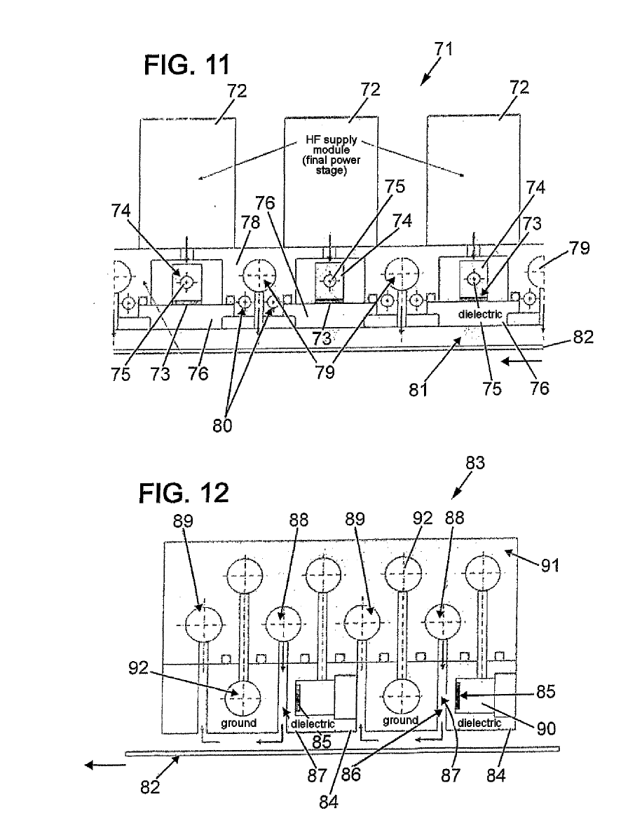

FIG. 11 shows, in cross section, an assembly of devices according to the invention;

FIG. 12 shows, in cross section, another assembly of devices according to the invention; and

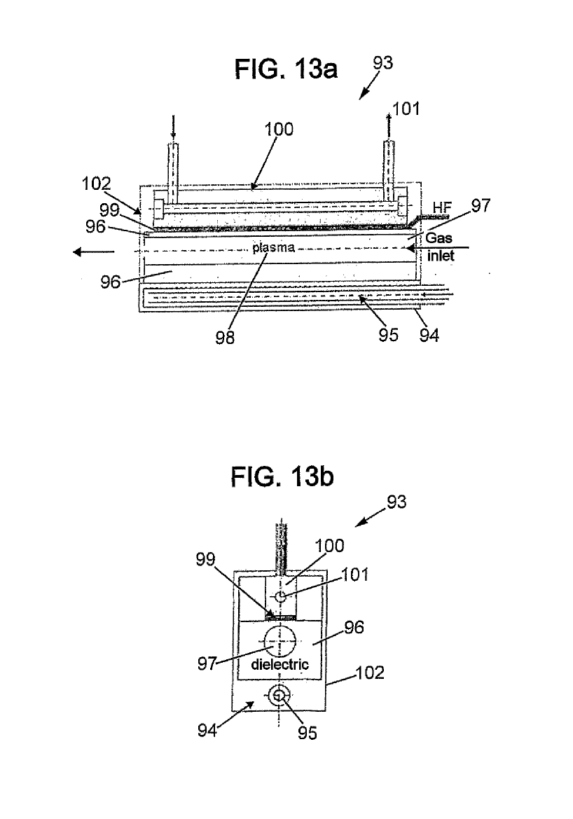

FIGS. 13a and 13b show longitudinal and cross sections of a plasma torch employing a device according to the invention.

FIGS. 1a and 1b illustrate schematically a device 1 according to the invention, in which the microstrip 2, which has a plane but curved shape, is connected to a very high-frequency generator. This microstrip 2 is fixed to the surface of a dielectric support 3, one edge of which coincides with one of the curved edges of the microstrip. Provided in the dielectric is a slot 4 into which the gas is injected and in which the plasma 5 is generated. A substrate 6 to be treated, on average perpendicular to the plane of the microstrip and having a warped shape matching the curvature of the dielectric and of the microstrip, is driven beneath the device in the direction indicated by the arrow. According to this embodiment, the substrate is perpendicular to the microstrip, the treatment is a post-discharge plasma treatment.

FIGS. 2a and 2b illustrate schematically a device 7 according to the invention, in which the microstrip 8 of warped shape is connected to a very high-frequency generator. This microstrip 8 is fixed to the actual warped surface of a dielectric 9. The gas is fed in close to the face 9a of the dielectric and the plasma is generated beneath the face 9a opposite the microstrip 8. A substrate 11 to be treated, having a warped shape matching that of the dielectric 9 and of the microstrip 8, is driven beneath the device 7 in the direction indicated by the arrow. In this embodiment, since the substrate 11 is perpendicular to the microstrip, the treatment is a direct plasma treatment.

FIGS. 3a to 3d show schematically the various ways of connecting the microstrip conductor to the very high-frequency power supply. Thus, according to a first embodiment (FIG. 3a), the microstrip 12 is supplied so as to propagate a traveling wave along the microstrip. The very high-frequency range generator is connected via a coaxial line, for example having a characteristic impedance of 50Ω (this value generally corresponding to the industrial standard) at only one end 12a of the microstrip 12, for the other end 12b being connected to a matched impedance load 14, that is to say there is no reflection of the waves at said end opposite the connection to the generator and therefore no standing wave along the microstrip. In this embodiment, the intensity of the wave decreases very substantially along the microstrip, owing to the gradual absorption of the power in order to sustain the plasma. Therefore, the latter is not very uniform along the microstrip.

According to a second embodiment, illustrated in FIG. 3b, the microstrip 15 is supplied so as to propagate two opposed traveling waves starting from each of its ends, so that their intensities add together. To do this, one end 15a of the microstrip is connected via a coaxial line 17 to a first very high-frequency wave generator 16 and the opposite end 15b of the microstrip is connected via a coaxial line 18 to a second very high-frequency wave generator 19. Since the phases of the signals of two separate generators are uncorrelated, it is the intensities of the two counter-propagating waves that add together, and not their amplitudes (this would result in the appearance, through interference, of a standing wave), partly compensating for the observed gradient with a single source at one end.

According to a third embodiment illustrated by FIG. 3c, the microstrip 20 is supplied so as to create a standing wave mode along the microstrip. One end 20a of the microstrip 20 is connected via a coaxial line 21 to a very high-frequency generator. A short-circuit device is connected to the other end 20b. This short-circuit device 22 is adjustable, so as to vary the complex reflection coefficient and match the impedance so as to optimize the characteristics of the standing wave.

According to a fourth embodiment illustrated by FIG. 3d, the microstrip 23 is supplied so as to create a standing wave mode along the microstrip. A very high-frequency generator is connected via a coaxial line 24 to a power divider device 25 (standard industrial equipment known to those skilled in the art), each of the branches 26a and 26b of which is connected to one end 23a and 23b of the microstrip 23. Since the phases of the waves coming from the same generator are correlated, it is clearly the amplitudes of the waves that add together, and not their intensities, giving rise by interference to a standing wave. As power divider, it is possible for example to use a Wilkinson-type device known in the literature.

FIGS. 4a to 4c show schematically three impedance matching modes.

Thus, in FIG. 4a, the very high-frequency generator is connected to the microstrip 27 via an impedance matching circuit which in this particular case is a T-network 28. In FIG. 4b, the very high-frequency generator is connected directly to the microstrip 29 on that side where the latter is provided with a microstrip stub 30 of length L and width W, the stub being perpendicular to the microstrip 29. By choosing the geometric parameters L and W it is possible to modify the electrical effect of the stub and thus apply the desired correction to the resulting impedance of the system. In FIG. 4c, the very high-frequency generator is connected to the microstrip 31 via a quarter-wave impedance transformer produced in the microstrip 32 lying in the longitudinal extension of the main microstrip and having an effective electrical length of λ/4, λ being the wavelength for propagation along the microstrip line attached to the substrate of a given dielectric constant, at the very high-frequency in question. The function of the quarter-wave impedance transformer is to enable the incident power coming from the generator to “see” an effective impedance equal to the characteristic impedance of the main microstrip line forming the field applicator, the plasma being ignited (the microstrip/plasma assembly constituting a complex load). The general rule in designing a quarter-wave impedance transformer on a transmission line is well known. If Z_{C} is the output impedance of the generator and Z_{L} is the characteristic impedance of the microstrip line (with the plasma ignited), the impedance Zₜ of the quarter-wave transformer will be zₜ=\sqrt{Z_{C}Z_{L}}.

FIG. 5 shows, in cross section, a device 33 according to the invention that comprises a microstrip 34 fixed to a dielectric which is a parallelepipedal element having an elongate recess forming a channel 36 and placed on a support 37 made of a conducting material, forming an electrical reference plane, penetrated over its entire height by a slot 38 and, on either side of said slot, by longitudinal slots 39a and 39b that are symmetrical with respect to the slot 38 and via which the gas is supplied. The conducting support 37 acts as a partial ground plane as defined above, the slot 38 being narrower and shorter than the microstrip 34 so that there is a conducting ground plane fraction facing the ends of the microstrip and opposite the lateral edges of said microstrip over its entire length. Fixed to the upper face of the dielectric 35a supporting the microstrip 34 is a housing 40 made of a dielectric material, in which housing a dielectric coolant 41 circulates, the entire microstrip 34 being in contact with the coolant 41. A Faraday cage 42 encloses the dielectric 35 and the housing for confining the coolant 40. The plasma 43 is generated in the channel 36 and the active species escape via the slot 38 in the direction of the arrow, because they are entrained by the gas stream.

FIG. 6 shows, in cross section, a device 44 according to the invention that differs from the embodiment shown in FIG. 5 by the fact that the insulating housing containing a coolant in contact with the microstrip is replaced with a heat sink 45, which is a parallelepiped made of a dielectric material pressed against the upper face surface (on the opposite side from the substrate and from the plasma) of the microstrip 34 and penetrated by a channel 47 in which a coolant 48 circulates, which is no longer necessarily a very good dielectric at the very high frequency in question, but may for example be water.

FIG. 7 shows, in cross section, a device 49 according to the invention that differs from the embodiment shown in FIG. 6 by the fact that the microstrip 34 and the dielectric heat sink 45 have been replaced with a transmission line element 50 which is a hollow conductor element of circular cross section in which a coolant 51 circulates. Of course, the surface 35a of the dielectric 35 has been modified in order to match the shape of the conductor element 50.

FIG. 8 shows, in cross section, a device 52 according to the invention that differs from the embodiment shown in FIG. 7 by the fact that the transmission line element 53 is a hollow conductor of rectangular cross section in which a coolant 51 circulates. The surface 35a of the dielectric 35 is then plane, as in the case of the embodiments shown in FIGS. 5 and 6.

A plasma generator device 54 provided with a cooling system such as that of FIG. 6 is shown completely in FIGS. 9a and 9b. This device 54 is made up of the following various elements stacked one on top of another:
a base 55 penetrated by two symmetrical longitudinal channels 56a and 56b in which water circulates and by two symmetrical channels 57a and 57b for delivering the gas entering the discharge with, at the center, an output slot 58 for extracting the active species from the plasma 59, it being necessary to cool the base because of the heat released by the plasma, which is in contact with the dielectric substrate;
a dielectric 60 forming, above said slot 58, a channel 61 of the same width as the microstrip 62 and with the same length;
said microstrip 62 consists of a conducting metal strip connected to the connector for transmitting the very high-frequency power coming from the generator, and being fixed above said dielectric 60; and
a ceramic dielectric heat sink 63 having a longitudinal channel 64 in which water circulates, said heat sink 63 being pressed against the entire surface of the microstrip 62.

A clamping system 65, for clamping the stack, enables the elements to be pressed against and held in place on the base 55. An O-ring seal (not shown) located in the lower part seals the volume in which the discharge develops.

The entire device is confined in a conducting housing 66 acting as a Faraday cage so as to avoid any leakage of radiation to the external environment, which would have associated safety and electromagnetic compatibility problems.

A plasma generator device 67 provided with a cooling system such as that of FIG. 7 is shown completely in FIGS. 10a and 10b.

This device 67 differs from that of FIGS. 9a and 9b by the fact that the microstrip 62/insulating heat sink 63 assembly is replaced with a longitudinal transmission line element of hollow circular cross section in which water circulates. The transmission line element is held in placed by a dielectric spacer inserted into the rest of the stack and immobilized by clamping means 70.

FIG. 11 shows an assembly 71 of three plasma generator devices (given as an example, it being possible for this number to be increased without any particular limit), each comprising a very high-frequency supply module 72 for supplying a microstrip conductor 73 with very high-frequency power. The microstrip is cooled by means of a dielectric heat sink 74, through the internal channel 75 of which water circulates. The microstrip is fixed to a dielectric substrate 76. The various units, each comprising a microstrip, dielectric, very high-frequency supply and dielectric heat sink, are held together by a distribution block incorporating gas supply lines 79 and cooling water supply lines 80. The plasma 81 is generated on the lower face of the dielectric substrate facing the microstrip. The substrate 82 to be treated runs beneath each of the plasma sources. If the substrate 82 is conducting, for example if a steel or aluminum sheet is to be treated, said substrate acts as ground plane. If the substrate is a dielectric, a ground plane fraction (not shown) must be provided beneath the dielectric box 76, for example a plane conducting element extending over a limited distance from that end of the microstrip supplied with power in the direction perpendicular to the plane of the figure (generic arrangement of FIG. 16).

FIG. 12 shows another type of assembly 83 comprising two dielectric 84/microstrip 85 units (this number of units not being limiting) enabling a plasma 86 to form in the slot 87 supplied with gas via the gas inlet 88. The gas is then entrained toward the gas outlet 89. The microstrip is cooled by circulation of a dielectric coolant in the channel 90 surrounding the microstrip. The distribution block 91 is cooled by water circulating in channels 92. According to the general principle of the invention, to maintain the plasma as potential reference and to avoid a resonant system, the ground blocks defining the slots 87 facing the microstrips 85 will be made of a conducting material only over a limited length starting from that end of the microstrip supplied with power, it being possible for the rest of the total length of the block (in the direction perpendicular to the plane of the figure) to consist of a dielectric rod.

FIG. 13 shows a plasma torch 93 comprising a base 94 incorporating a coaxial longitudinal channel 95 which is closed at one end and in which water circulates, with an inlet and an outlet at the other end. Placed above this base 94 is a dielectric 96 penetrated right through by a longitudinal channel 97 into which the gas is injected and in which the plasma 98 is generated. The microstrip 99 connected to the very high-frequency generator is fixed above the dielectric. Placed on the free face of the microstrip 99 is a dielectric heat sink in which water 101 circulates. The assembly is inserted into a Faraday cage 102.

1-23. (canceled)

24. A plasma generator device which comprises at least one source of power with a frequency above 100 MHz, said source being connected via an impedance matching system to an elongate conductor fixed in intimate contact over its entire lower surface to a dielectric support, at least one means for cooling said conductor and at least one gas feed close to the dielectric support on the opposite side from the side supporting the conductor.

25. The device of claim 24, wherein the conductor has a thickness of the order of one millimeter.

26. The device of claim 24, wherein the conductor is a microstrip.

27. The device of claim 24, wherein the conductor is a hollow elongate element, especially of round, rectangular or square cross section.

28. The device of claim 24, wherein said device includes a partial electric ground plane that lies facing a face of the dielectric on the opposite side from the side supporting the conductor, the partial character of the ground plane being expressed by the fact that only a minor area of the conductor line is facing a ground plane.

29. The device of claim 28, wherein the partial ground plane is located at the start of the conductor line, the point where the microwaves enter the device.

30. The device of claim 29, wherein the wave launch zone, at the input of the conductor line, has a conventional structure in which the elongate conductor, the dielectric and the partial ground plane are assembled, the ground plane being interrupted at a short distance from the input of the conductor line and then being replaced with the plasma extending with the conductor over the entire rest of the length of the conductor line.

31. The device of claim 29, wherein the wave launch zone, at the input of the conductor line, has a conventional structure in which the elongate conductor, the dielectric and the partial ground plane are assembled, the ground plane being interrupted at a short distance from the input of the conductor line and then being replaced with the plasma, the conductor not extending substantially beyond the boundary of the ground plane.

32. The device of claim 24, wherein the conductor is made of a copper alloy chosen from the group comprising brass and, preferably, beryllium copper.

33. The device of claim 24, wherein the conductor is mechanically fixed to the dielectric.

34. The device of claim 24, wherein the conductor is screen-printed onto the dielectric.

35. The device of claim 24, wherein the dielectric has a dielectric loss tangent tanδ of between 10⁻⁴ and 10⁻².

36. The device of claim 24, wherein the dielectric is silica or a ceramic, preferably aluminum nitride or boron nitride.

37. The device of claim 24, wherein the device is placed in a conducting housing acting as a Faraday cage.

38. The device of claim 24, wherein a dielectric housing is placed on the dielectric substrate of the conductor line and above the conductor, and in that a coolant of low dielectric loss circulates in said housing.

39. The device of claim 24, wherein a heat sink made of a dielectric material, through which a coolant flows, is placed over the entire free face of the conductor.

40. The device of claim 24, wherein the elongate conductor is a hollow longitudinal conductor provided at each of its ends with an opening for the circulation of a coolant.

41. The device of claim 24, wherein it includes means for cooling the dielectric substrate.

42. The device of claim 41, wherein the dielectric has channels in which a coolant circulates, or in that the dielectric is placed on a support having channels in which a coolant circulates.

43. The device of claim 24, wherein the surface of the conductor is coated with a coating of a metal which is a good electrical conductor and is resistant to oxidation, such as gold.

44. The device of claim 24, wherein said impedance matching system is produced from impedance matching components produced in the actual structure of the conductor.

45. A plasma generator device, comprising at least two of the devices claim 24.

46. A plasma torch comprising at least one very high-frequency source connected via an impedance matching device to an elongate conductor, fixed to a dielectric support, and at least one means for cooling said conductor, said dielectric support being longitudinally penetrated by a channel via one end of which the gas is injected and in which the plasma forms, the active species of said plasma being extracted by the gas flow via the opposite end.
